(19) United States
(12) Patent Application Publication
(10) Pub. No.: US 2024/0338551 A1
(43) Pub. Date: Oct. 10, 2024

(54) DISTRIBUTED TRAINING OF GRAPH NEURAL NETWORKS (GNN) BASED KNOWLEDGE GRAPH EMBEDDING MODELS

(71) Applicant: International Business Machines Corporation, Armonk, NY (US)

(72) Inventors: Nasrullah Sheikh, San Jose, CA (US); Xiao Qin, San Jose, CA (US); Berthold Reinwald, San Jose, CA (US)

(21) Appl. No.: 18/295,306

(22) Filed: Apr. 4, 2023

(51) Int. Cl. G06N 3/042

(52) U.S. Cl. CPC G06N 3/042

(57) ABSTRACT

Aspects of the invention include techniques for scaling the training of graph neural network (GNN)-based knowledge graph embedding models for link prediction. A non-limiting example method includes receiving a knowledge graph of a data set and partitioning the knowledge graph into a plurality of partitions. At least one partition of the plurality of partitions is expanded. The method includes launching a training process for each partition of the plurality of partitions such that, during a training epoch, a respective training process samples positive and negative samples from a respective partition. An edge mini batch is formed for each training process and a computational graph is generated for each edge mini batch.

### STATEMENT REGARDING PRIOR DISCLOSURES BY THE INVENTOR OR A JOINT INVENTOR

The following disclosure(s) are submitted under 35 U.S.C. 102(b)(1)(A):

DISCLOSURES: Nasrullah Sheikh, et al., Scaling Knowledge Graph Embedding Models for Link Prediction, EuroMLSys, 2022 Apr. 5-8, RENNES, France, pages 87-94.

### BACKGROUND

The present invention generally relates to graph neural networks (GNNs), and more specifically, to computer systems, computer-implemented methods, and computer program products for the distributed training of GNN-based knowledge graph embedding models.

Modern data are relational in nature with dynamic interactions between entities and complex dependency structures. Constantly evolving social networks, temporal user-item relationships in e-commerce, and dynamic financial transactions are only a few examples of the data naturally being represented in the form of dynamic graphs. The ability to extract insights from such evolving relational data provides enterprises with a competitive advantage. For example, an IT procurement graph integrates buyer and seller's entities through various types of purchase related relations such as maintenance contracts, technical support agreements and equipment purchases. The relationships evolve constantly depending on the buyers' financial planning, strategic priorities, and sellers' offerings. Being able to extract insights from these changes allows companies to make timely and strategic recommendations.

Graphs are widely used to model and manage relational data. Knowledge graphs, for example, model real-world objects, events, and concepts as well as various relations among them. Representation learning on large-scale knowledge graphs has been emerging as a pivotal tool to derive insights from graph structured data powering a wide range of applications such as data integration and question answering. Knowledge graph embedding methods capture the attributes of entities and structures of relations in knowledge graphs, and project them into a lower dimensional vector space for use in various downstream tasks, such as, for example, node classification and link prediction. Traditional knowledge graph embedding methods learn various patterns between the entities such as symmetric, anti-symmetric, and inverse relations. These embedding methods mainly focus on the scoring aspect of the embedding problem, which is to predict the legitimacy between two entities and a particular relation type.

Recently, message passing-based GNNs have been adopted to improve the expressive power of entity embeddings. GNNs can capture the topological features of the entities, such as shapes of the neighborhood sub-graphs, which can be overlooked by traditional knowledge graph embedding methods.

### SUMMARY

Embodiments of the present invention are directed to techniques for scaling the training of graph neural network (GNN)-based knowledge graph embedding models for link prediction. A non-limiting example method includes receiving a knowledge graph of a data set and partitioning the knowledge graph into a plurality of partitions. At least one partition of the plurality of partitions is expanded. The method includes launching a training process for each partition of the plurality of partitions such that, during a training epoch, a respective training process samples positive and negative samples from a respective partition. An edge mini batch is formed for each training process and a computational graph is generated for each edge mini batch.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block diagram of a distributed training module in accordance with one or more embodiments of the present invention;

FIG. 3A depicts an example graph partitioning in accordance with one or more embodiments of the present invention;

FIG. 3B depicts a plurality of edge-cut partitions and their neighborhood expansions after partitioning an input graph using an edge-cut partitioning method in accordance with one or more embodiments of the present invention;

FIG. 3C depicts a plurality of vertex-cut partitions and their neighborhood expansions in accordance with one or more embodiments of the present invention;

FIG. 4 depicts an example distributed training pseudocode in accordance with one or more embodiments of the present invention;

FIG. 5 depicts an example 1-hop computational graph in accordance with one or more embodiments of the present invention;

FIG. 6 depicts a graph of an average running time per epoch as a function of a number of trainers and a number of batches in accordance with one or more embodiments of the present invention;

FIG. 7 depicts a graph of an average running time of different components in a batch in accordance with one or more embodiments of the present invention; and

FIG. 8 is a flowchart in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified.

In the accompanying figures and following detailed description of the described embodiments of the invention, the various elements illustrated in the figures are provided with two or three-digit reference numbers. With minor exceptions, the leftmost digit(s) of each reference number correspond to the figure in which its element is first illustrated.

### DETAILED DESCRIPTION

Message passing-based graph neural networks (GNNs) have been adopted to improve the expressive power of knowledge graph entity embeddings. GNNs can capture the topological features of the entities, such as shapes of the neighborhood sub-graphs, which can be overlooked by traditional knowledge graph embedding methods.

Notably, leveraging GNNs to learn better embeddings comes at the cost of increased model complexity, particularly in terms of the number of trainable parameters. For example, a base knowledge graph model having 1.5 million parameters might require a GNN model having nearly double the parameters (e.g., 3.3 million parameters) with an embedding size of 100. The increased number of trainable parameters leads to an increase in training time. Besides model complexity, the size of modern input knowledge graphs has also grown exponentially. Consider, for example, the exponential growth of modern social networks, which can include billions of vertices and trillions of edges. Iterative training on these large graphs may not be feasible on single node systems due to the high computational cost and high memory requirements.

Various distributed training frameworks have been proposed to scale knowledge graph embedding methods. However, these frameworks natively apply to models having mutually independent training triplets. Under these frameworks the input data can be partitioned somewhat easily, and the models can be subsequently trained in parallel.

Unfortunately, these distributed training frameworks cannot be used for training GNN-based knowledge graph embedding models due to the inherent dependencies in the neighborhood information (usually beyond n-hop with n≥2). Moreover, as neighborhoods become larger and deeper, the average number of vertices required to compute an embedding rises significantly for a GNN-based knowledge graph, which consequently leads to an increase in the number of model parameters with more computation cost and higher memory footprint. Complicating matters further, the skewed distribution of vertex degrees in enterprise knowledge graphs can lead to vertex dependencies up to tens of thousands of vertices. These vertex dependencies make scaling GNN-based knowledge graph embedding models extremely challenging. In other words, as a result of inherent data dependencies, which entail high computational costs and a large memory footprint, scalable solutions for training GNNs for link prediction and other tasks are of great interest.

Several distributed GNN training frameworks have been proposed, primarily for node classification. These solutions typically involve a graph partitioning followed by distributed training. A simple partitioning strategy might be to partition the graph using either vertex-cut or edge-cut-based methods, and to access required dependent vertices in other partitions remotely during training. However, observe that the increase of the number of GNN layers, i.e., the number of hops, increases the number of messages with neighborhood information that are exchanged across partitions, which leads to a significant communication overhead. This phenomenon is in contrast to distributed neural network training on non-graph structured datasets, such as images, which only incur communication overhead due to the sharing of gradients.

The exchange of neighborhood information is a major bottleneck in scaling GNN training. One challenge is to generate optimized graph partitions that reduce the required exchange of neighborhood information. Moreover, partitions generated from larger graphs can be of considerable size and might not fit into the relatively smaller memory of a GPU for hardware acceleration.

Some distributed GNN training frameworks leverage an edge-cut based partitioning method and a mini-batch training approach for node classification. Edge-cut-based methods produce partitions with edge replication in multiple partitions, which may lead to skewed partition sizes. The larger partitions will often be the stragglers in the training process. In addition, partitions produced by edge-cut-based methods followed by neighborhood expansion for link prediction can be approximately 33% larger than the partitions produced by vertex-cut based methods, which can increase training time by approximately 21%—a sub optimal approach for link prediction.

This disclosure introduces new methods, computing systems, and computer program products for scaling the training of GNN-based knowledge graph embedding models for link prediction. In particular, a distributed training approach is proposed that leverages a vertex-cut method to partition the graph and then expands the resultant partitions to include n-hop neighbors. In some embodiments, n is determined by the number of convolutional layers of the GNN model. In some embodiments, the partitions produced are self-sufficient and, consequently, do not require any exchange of neighborhood information during distributed training at the expense of data replication and redundant computation. In some embodiments, negative samples are generated within the partitions to further reduce the communication overhead. The generation of negative samples can be referred to as constraint-based negative sampling. In some embodiments, the model is trained in a cluster using a data parallel approach where each trainer process (of an arbitrary number of trainer processes) trains on a partition using an edge mini-batch training strategy. In this manner, scaling the training of a GNN-based knowledge graph embedding model involves a combination of self-sufficient partitions, constraint-based negative sampling, and edge mini-batch training.

Notably, scaling the training of GNN-based knowledge graph embedding models using a combination of self-sufficient partitions, constraint-based negative sampling, and edge mini-batch training in accordance with one or more embodiments described herein offers various technical advantages over prior distributed GNN training frameworks. In particular, experimental evaluations have empirically demonstrated an approximately 16× increase in training speed with 8 trainers against benchmark datasets while maintaining a comparable model performance to a non-distributed framework on standard metrics. Other advantages are possible. For example, edge mini-batch training allows for training over relatively larger partitions than are available using prior frameworks.

The architectures described herein can employ a vertex-cut-based partitioning strategy that partitions a graph into sets of disjoint edges. Advantageously, these disjoint edges can be expanded to self-contained graph partitions by replicating n-hop dependent vertices and edges required for message passing.

In some embodiments, the so-called locally closed world assumption is leveraged in combination with a constraint based negative sampling strategy to sample negative samples. Advantageously, the negative samples can be drawn from within the partition to avoid communication overhead.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

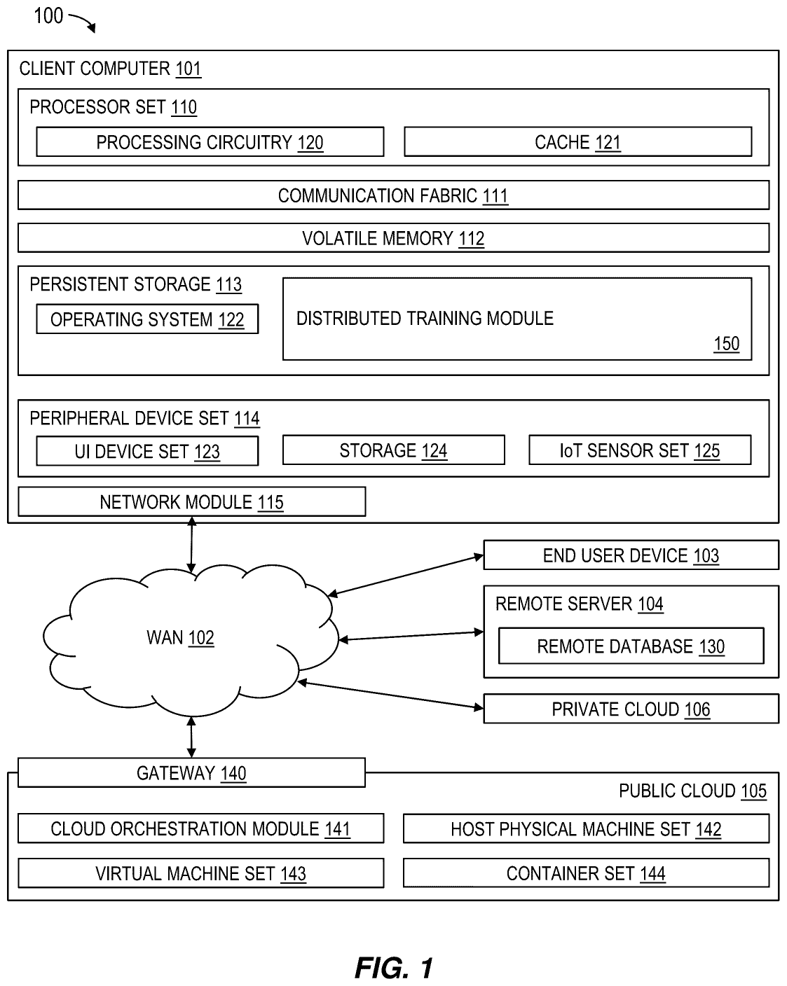

Referring now to FIG. 1, computing environment 100 contains an example of an environment for the execution of at least some of the computer code involved in performing the inventive methods, such as distributed training module 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

### Distributed Knowledge Graph Training

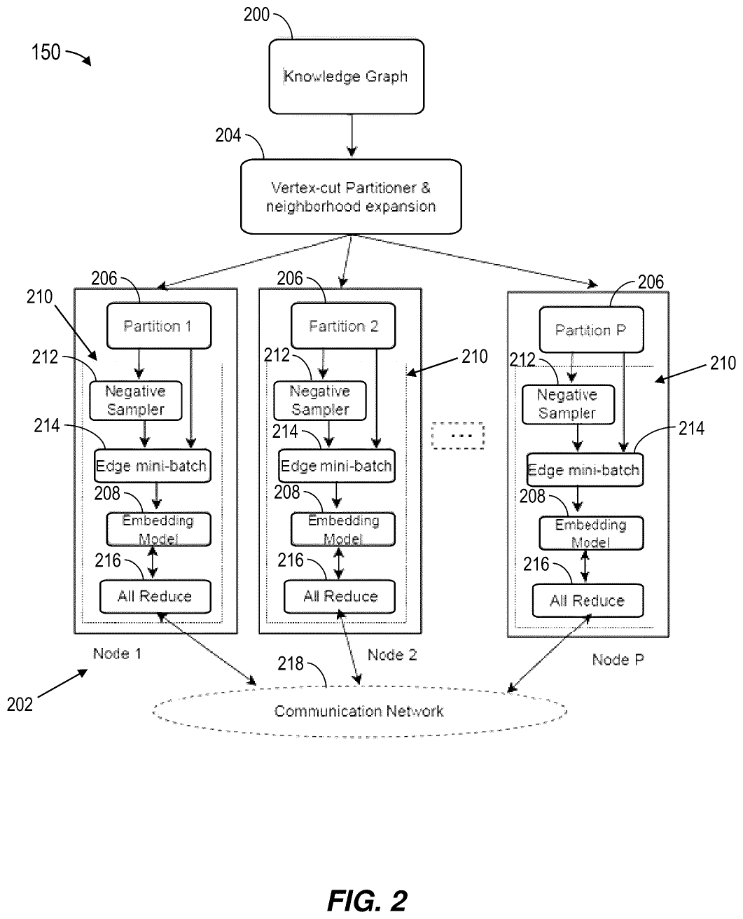

FIG. 2 depicts a block diagram of a distributed training module 150 in accordance with one or more embodiments of the present invention. In some embodiments, the distributed training module 150 includes a knowledge graph 200. In some embodiments, the distributed training module 150 can include a cluster of compute nodes 202 (as shown, node 1, node 2, . . . , and node P), each having one or more processing units (e.g., CPUs, GPUs, etc.). The number of compute nodes 202 is not meant to be particularly limited and distributed training modules having any number of compute nodes are within the contemplated scope of this disclosure.

In some embodiments, the distributed training module 150 is configured for distributed GNN training for link prediction. In some embodiments, distributed training module 150 is configured for distributed knowledge graph embedding learning according to the following procedure.

### Step 1: Graph Partitioning

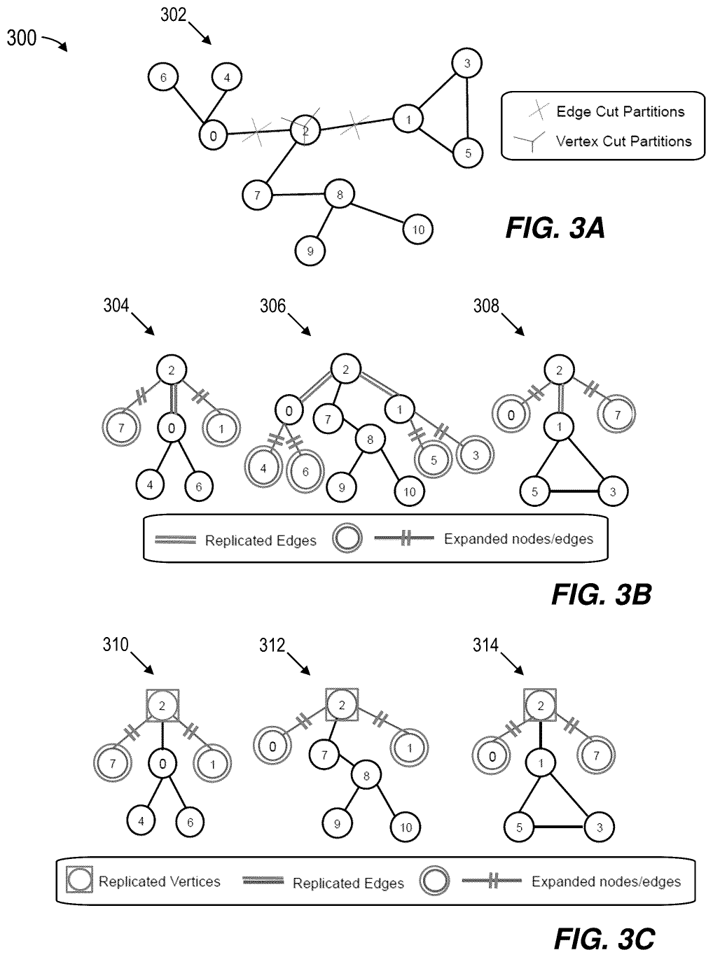

In some embodiments, the knowledge graph 200 is partitioned into P disjoint subsets (referred to herein as graph partitions 206). In some embodiments, the knowledge graph 200 is received by a vertex-cut partitioner and neighborhood expansion module 204 configured to partition the knowledge graph 200 into the P disjoint subsets, and expand each partition to include n-hops of neighbors of each vertex in the respective partition, producing graph partitions 206. The number of partitions n is determined by the number of graph convolutional layers in an embedding model 208 (refer to STEP 4). The embedding model 208 can include any graph embedding model which uses a message passing approach for graph convolution, such as, for example, a GNN-based knowledge graph embedding model. In some embodiments, the number of graph partitions 206 is equal to the number of available compute nodes 202. In some embodiments, each graph partition 206, along with the required features of vertices, is assigned to a respective one of the compute nodes 202. Graph Partitioning is discussed in greater detail with respect to FIGS. 3A, 3B, and 3C.

### Step 2: Negative Sampling

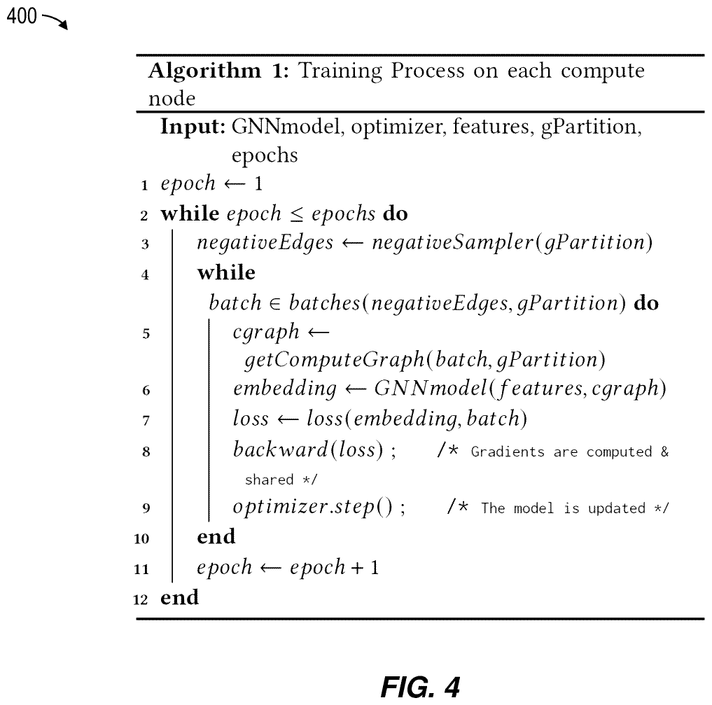

In some embodiments, one training process/worker (referred to herein as worker 210) is launched per compute node 202. In some embodiments, training involves a number of training epochs. In some embodiments, during each training epoch, each training worker 210 samples s negative samples, via a negative sampler 212, for each positive sample in its respective partition 206. Observe that the number of training examples in a partition is px (s+1), where p is the number of positive samples in a partition. Negative sampling is discussed in greater detail below with respect to Algorithm 1 and FIG. 4.

### Step 3: Edge Mini Batching

In some embodiments, each training worker 210 implements an edge mini-batch module 214 for batch training (referred to herein as mini-batching). In some embodiments, a batch of b edges (positive and negative) in a partition 206 is sampled. In some embodiments, the edge mini-batch module 214 is configured to compute the embedding of all entities required for scoring the b edges. In some embodiments, mini-batching includes randomly selecting a set of vertices in the respective partition 206, and sampling the resultant computational sub-graph (also referred to as an edge mini-batch) for training to obtain embeddings of the selected vertices. Edge mini batching is discussed in greater detail with respect to FIG. 4.

### Step 4: Embedding Model Generation

In some embodiments, after the formation of an edge mini-batch (refer to STEP 3), a computational graph (e.g., an embedding model 208) can be generated for message passing in the underlying graph convolutional layers. In some embodiments, a loss is calculated and the gradients are computed. In some embodiments, the gradients are shared using an all reduce module 216. In some embodiments, the embedding model 208 is optimized based on the averaged gradients, resulting in an updated embedding model. Notably, such an approach can be applied to any graph embedding model which uses a message passing approach for graph convolution. Embedding model generation and gradient descent is discussed in greater detail below.

Advantageously, configuring a distributed knowledge graph embedding learning process (refer to STEPS 1 to 4) in this manner ensures that each compute node 202 (e.g., CPU/GPU of node 1, node 2, etc.) in the cluster runs a replica of the embedding model 208 and is responsible for training on a partition 206 of the knowledge graph 200 using synchronous gradient descent (SGD). Moreover, each worker 210 computes the respective gradients of the local (replica) embedding model 208 on an edge mini-batch basis, shares and averages the gradients, and updates the local embedding model 208. In some embodiments, the resultant output (e.g., gradients from the embedding model 208) can be transmitted over a communication network 218 to one or more downstream systems and/or users.

### Illustrative Example—Graph Partitioning and Neighborhood Expansion

FIG. 3A depicts an example graph partitioning 300 in accordance with one or more embodiments of the present invention. As shown in FIG. 3A, in some embodiments, an input graph 302 is segmented using one or more edge-cut partitions (indicated by a stylized “X”; refer to FIG. 3B) and/or one or more vertex-cut partitions (indicated by a stylized “Y”; refer to FIG. 3C). In some embodiments, partitioning the input graph 302 is a preprocessing step in a distributed training workflow (refer to STEPS 1 to 5). Observe that the quality of the resultant partitions will have a direct impact on the learned model quality and on scalability. In some embodiments, graph partitioning 300 is a two-phase partitioning process whereby (1) the input graph 302 is first partitioned, and then (2) a neighborhood expansion operation is performed to make the partitions self sufficient. The two-phase partitioning process is discussed in greater detail with respect to FIG. 3C.

FIG. 3B illustrates a plurality of edge-cut partitions (e.g., a first edge-cut partition 304, a second edge-cut partition 306, and a third edge-cut partition 308) and their neighborhood expansions after partitioning the input graph 302 using an edge-cut partitioning method in accordance with one or more embodiments of the present invention. The particular edge-cut partitioning method employed is not meant to be particularly limited and can include, for example, known edge-cut partitioning methods such as Metis. Observe that, when using an edge-cut partitioning method, one or more positive edges are replicated in multiple partitions 304, 306, 308. For example, the edges (0, 2) and (1, 2) are present in all three partitions 304, 306, 308. Replicated positive edges are referred to herein as replicated edges (indicated by a double line). Hence, the training on the replicated edges is repeated in multiple partitions which incurs additional computational cost, and may also negatively impact the learning process. Moreover, edge-cut partitioning is known to be somewhat ineffective in balancing the workload of large real-world graphs. Load imbalance can lead to a substantial stalling of work-increasing the overall training time.

FIG. 3C illustrates a plurality of vertex-cut partitions (e.g., a first vertex-cut partition 310, a second vertex-cut partition 312, and a third vertex-cut partition 314) along with their neighborhood expansions in accordance with one or more embodiments of the present invention. As shown in FIG. 3C, vertex-cut partitioning divides the edges of the input graph 302 into P (here, 3) disjoint partitions and produces balanced partitions by minimizing vertex replication. As used herein, edges in a partition (e.g., the first vertex-cut partition 310) can be referred to as core edges (indicated by non-stylized edges), vertices where the input graph 302 is partitioned can be referred to as replicated-vertices (indicated by a stylized circle-in-square), and other vertices can be referred to as core-vertices (indicated by non-stylized vertices). In some embodiments, the set of core edges form the positive edges for training. Observe that the disjoint partitions 310, 312, 314 produced by a vertex-cut partition are more suited for the problem of link-prediction because, at minimum, the produced partitions are balanced and neighborhood expansion does not lead to an exponential increase in graph size.

In some embodiments, link prediction requires updated embeddings of the vertices of an edge to calculate a score that determines a validity of the respective edge. In some embodiments, to compute an embedding of a vertex, an n layer GNN requires features from one or more n-hop neighbors. Note that, due to partitioning, some edges will have only partial neighborhood information available within the partition, and the other required information could be present in a different partition(s). Edges having only partial neighborhood information can be referred to herein as boundary-edges. One way to recover the partial neighborhood information is to fetch the partial neighborhood information during training. This type of solution will necessarily incur recurring communication costs, resulting in extensive training time.

To solve this problem, in some embodiments, the vertex-cut partitioning process is modified by including the missing partial neighborhood information of the boundary edges in each respective partition-ensuring that the resultant partitions are fully independent. This process is referred to herein as “neighborhood expansion” and can be done after creating the partitions 310, 312, 314. Advantageously, neighborhood expansion eliminates the communication cost of fetching data from other partitions, but at the expense of increasing the size of each partition. The added vertices (also referred to as expanded nodes and/or as support-vertices) are indicated by stylized double circles. The added edges (also referred to as expanded edges and/or as support-edges) are indicated by stylized double-crossed lines. Compare the effects of neighborhood expansion in FIGS. 3B and 3C and observe that the size (number of edges and vertices) of the edge-cut partitions 304, 306, 308 rapidly increases as compared to the size of the vertex-cut partitions 310, 312, 314 after applying a neighborhood expansion, limiting the usability of vertex-cut partitioning.

### Illustrative Example—Training and Negative Sampling

As discussed previously, each compute node can have a replica of a graph embedding model and can be tasked to work on a single graph partition. In some embodiments, the partition assigned to a compute node remains fixed during the entire training process. In some embodiments, a set of negative edges are generated, and the combined set of negative edges and core edges define the set of training edges. In some embodiments, an edge mini-batch training approach is leveraged to train a knowledge graph embedding method.

FIG. 4 depicts an example distributed training pseudocode 400 (“Algorithm 1”) in accordance with one or more embodiments of the present invention. As shown in FIG. 4, distributed training pseudocode 400 receives, as input, a GNN model, an optimizer, features, partition data (gPartition), and a number of training epochs. As further shown in FIG. 4, distributed training pseudocode 400 includes, for each epoch, defining a set of negative edges (negativeEdges) and, for each batch, fetching a compute graph (getComputeGraph), computing an embedding, determining a loss, backward propagation (where gradients are computed and shared), and optimizing via model update.

In some knowledge graph embedding methods, negative samplers generally exploit the closed world hypothesis, which considers any edge not explicitly present in the graph as a negative example. Most of the negative samples generated by this result are so-called easy negative examples. Observe that the error gradients from these samples are inherently very small, hence they are not particularly helpful in training a good model. Moreover, the negative samples space is of O(N²) and is far larger than the positive samples space-thus, the negative samples space is more prone to generate these easy negative samples.

To solve this problem, in some embodiments, a constraint-based negative sampling approach is leveraged whereby the core edges in a partition are considered as the positive samples, and each partition is independent of other partitions (as discussed previously). In some embodiments, a constraint can be employed that generates the negative samples from the core vertices of the partition based on a local world hypothesis. Notably, this type of constraint construction provides two advantages: (1) the embeddings of the entities in negative samples are not stale, and (2) the communication costs of querying other partitions and fetching data is avoided. A constraint-based negative sampling approach also reduces the sample space of negative samples, as Nᵢ<<N, where Nᵢ is a number of vertices in the i-th partition and N is the total number of vertices in a knowledge graph, respectively. Reducing the sample space of negative samples in this manner helps in reducing the problem (inherent to closed world hypothesis exploiting negative samplers) of generating easy negative samples.

### Illustrative Example—Edge Mini-Batching

As discussed previously, GNN training on a large dataset for node classification can be done by mini-batching. In some embodiments, mini-batching includes randomly selecting a set of vertices and sampling a computational sub-graph for training to obtain the embeddings of the selected vertices. Note that using a vertex sampling strategy for link prediction is not trivial as a vertex sampling strategy does not natively guarantee that both vertices of an edge are in the sample.

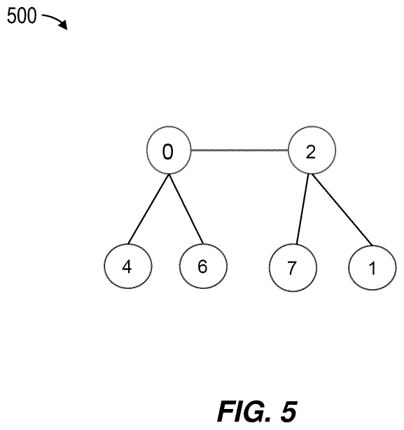

For this reason, in some embodiments, edge mini-batching is leveraged for link prediction. In edge mini-batching, a batch of edges is sampled, and the vertices in the batch form a vertex set. Then, a computational graph for message passing can be created which captures the n-hop dependencies of the sampled edge batch. The embeddings can be learned for the vertices in the vertex set. FIG. 5 shows an example 1-hop computational graph 500 for an edge (0, 2) in accordance with one or more embodiments. In some embodiments, message passing can be done on the graph 500 to learn the embeddings of vertex 0 and 2.

### Illustrative Example—Embedding Model and Gradient Descent

In some embodiments, for each edge in a mini-batch training routine, a computational graph (local embedding model) can be generated from the partitioned data using the vertices in the respective partition. In some embodiments, the computational graph can be used for generating embeddings for the vertices in the edge mini-batch using the graph convolutional layers of the knowledge graph embedding model-defining, for example, the forward pass of a training workflow. In some embodiments, a loss can then be calculated for the set of edges in the mini-batch, subsequently generating gradients. In some embodiments, the gradients are shared among the training processes using a communication primitive (e.g., the all reduce module 216). In some embodiments, once the gradients are shared and averaged, the training processes can update their local model (in other words, generate an updated local embedding model).

### Experimental Evaluation

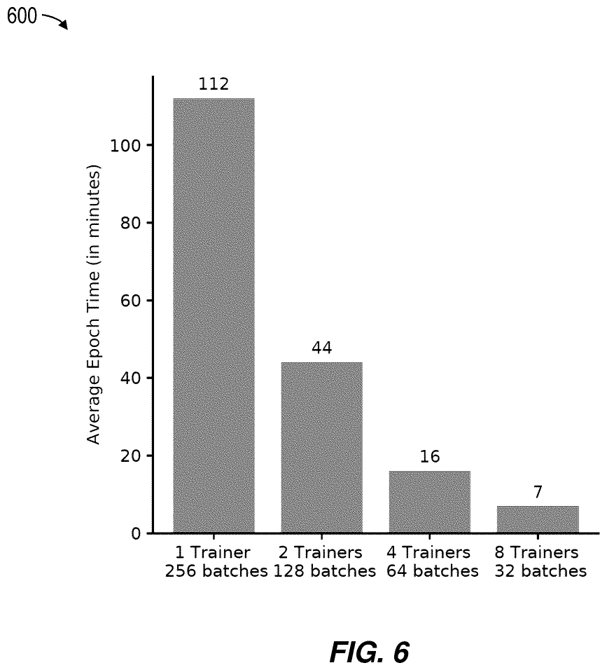

FIG. 6 depicts a graph 600 of an average running time per epoch as a function of a number of trainers and a number of batches in accordance with one or more embodiments of the present invention. As shown in FIG. 6, the average running time per epoch decreases as the number of trainers and batches increases. Note that the base average epoch time decreased from 112 minutes for 1 trainer and 256 batches to 7 minutes for 8 trainers and 32 batches, a decrease of 93.75%.

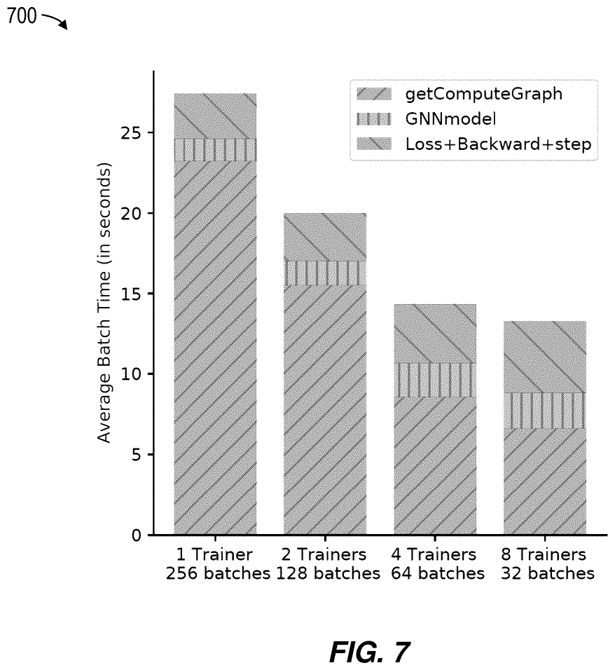

FIG. 7 depicts a graph 700 of an average running time of different components in a batch in accordance with one or more embodiments of the present invention. As shown in FIG. 7, the component “getComputeGraph” (refer to Algorithm 1) is a very compute intensive operation as it depends on the partition size. The getComputeGraph function returns a computational graph for an edge minibatch. In this manner, the getComputeGraph function enables training on large graphs. Observe that the running time of the getComputeGraph operation decreases as the number of trainers increases from 1 to 8 because the size of the partitions decreases. In the case of 8 partitions (and trainers in a 1:1 configuration as discussed previously), the size of each partition decreases by one third with respect to the full graph. The component “GNNmodel” produces the embeddings of the vertices in an edge mini-batch. In some embodiments, the running time in case of multiple trainers will be slightly higher than for 1 trainer, as 2 (or more) trainers, which share the same resources, can be run per machine. Note that the running time of the “loss+backward+step” component increases as the number of trainers increases as a result of the increase in communication cost for gradient sharing. The overall impact of these components on training time varies because the number of batches (forward pass and backward pass) per epoch decreases from 256 to 32 for 1 trainer and 8 trainers, respectively.

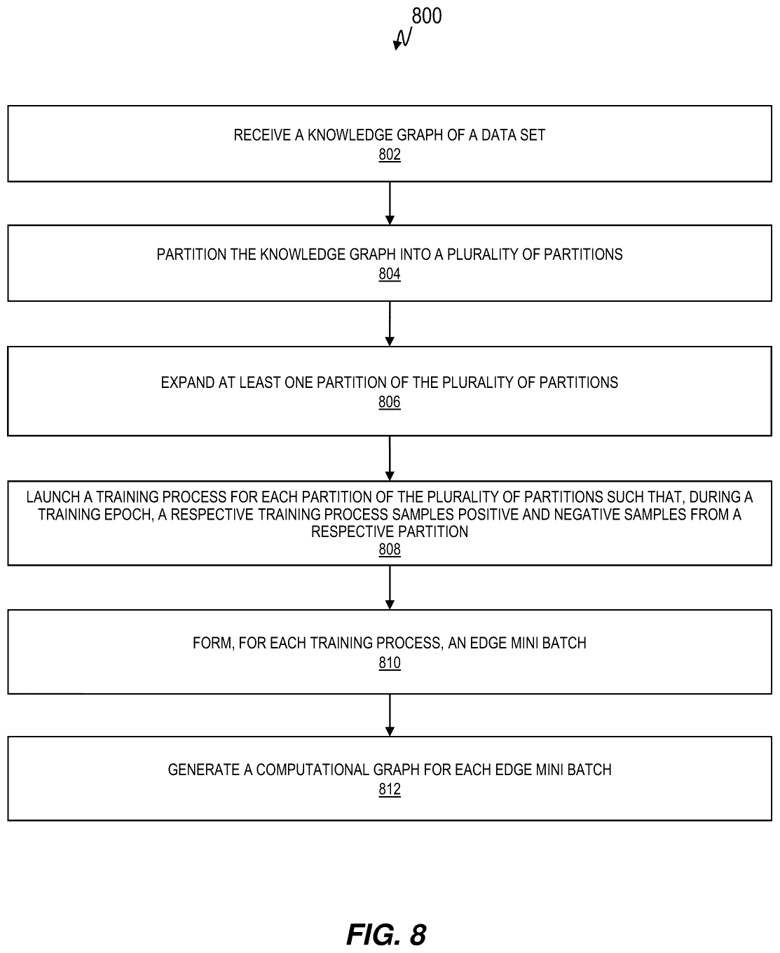

Referring now to FIG. 8, a flowchart 800 for scaling the training of GNN-based knowledge graph embedding models for link prediction is generally shown according to an embodiment. The flowchart 800 is described in reference to FIGS. 1-7 and may include additional blocks not depicted in FIG. 8. Although depicted in a particular order, the blocks depicted in FIG. 8 can be rearranged, subdivided, and/or combined. In exemplary embodiments, the method 800 can be performed by a computing environment (e.g., computing environment 100 shown in FIG. 1).

At block 802, a knowledge graph of a data set is received. At block 804, the knowledge graph is partitioned into a plurality of partitions. In some embodiments, partitioning the knowledge graph includes partitioning the knowledge graph into P disjoint subsets. In some embodiments, a number of the plurality of partitions equals a number of available computing nodes.

At block 806, at least one partition of the plurality of partitions is expanded. In some embodiments, expanding the at least one partition includes adding n-hops of neighbors of each vertex in the respective partition, where n is equal to a number of graph convolutional layers in an embedding model.

At block 808, a training process is launched for each partition of the plurality of partitions. In some embodiments, during a training epoch, a respective training process samples positive and negative samples from a respective partition.

At block 810, an edge mini batch is formed for each training process. At block 812, a computational graph is generated for each edge mini batch. In some embodiments, the computational graph (local embedding model) can be generated from the partitioned data using the vertices in the respective partition.

In some embodiments, the method 800 further includes determining a gradient according to each respective computational graph. In some embodiments, a determined gradient is shared across two or more partitions of the plurality of partitions. In some embodiments, an updated embedding model is determined according to an average of the gradients.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a knowledge graph of a data set;
partitioning the knowledge graph into a plurality of partitions;
expanding at least one partition of the plurality of partitions;
launching a training process for each partition of the plurality of partitions, wherein, during a training epoch, a respective training process samples positive and negative samples from a respective partition;
forming, for each training process, an edge mini batch; and
for each edge mini batch, generating a computational graph.

2. The computer-implemented method of claim 1, further comprising determining a gradient according to each respective computational graph.

3. The computer-implemented method of claim 2, further comprising sharing a determined gradient across two or more partitions of the plurality of partitions.

4. The computer-implemented method of claim 3, further comprising determining an updated embedding model according to an average of the gradients.

5. The computer-implemented method of claim 1, wherein partitioning the knowledge graph comprises partitioning the knowledge graph into P disjoint subsets.

6. The computer-implemented method of claim 1, wherein expanding the at least one partition comprises adding n-hops of neighbors of each vertex in the respective partition, where n is equal to a number of graph convolutional layers in an embedding model.

7. The computer-implemented method of claim 1, wherein a number of the plurality of partitions equals a number of available computing nodes.

8. A system having a memory, computer readable instructions, and one or more processors for executing the computer readable instructions, the computer readable instructions controlling the one or more processors to perform operations comprising:
receiving a knowledge graph of a data set;
partitioning the knowledge graph into a plurality of partitions;
expanding at least one partition of the plurality of partitions;
launching a training process for each partition of the plurality of partitions, wherein, during a training epoch, a respective training process samples positive and negative samples from a respective partition;
forming, for each training process, an edge mini batch; and
for each edge mini batch, generating a computational graph.

9. The system of claim 8, further comprising determining a gradient according to each respective computational graph.

10. The system of claim 9, further comprising sharing a determined gradient across two or more partitions of the plurality of partitions.

11. The system of claim 10, further comprising determining an updated embedding model according to an average of the gradients.

12. The system of claim 8, wherein partitioning the knowledge graph comprises partitioning the knowledge graph into P disjoint subsets.

13. The system of claim 8, wherein expanding the at least one partition comprises adding n-hops of neighbors of each vertex in the respective partition, where n is equal to a number of graph convolutional layers in an embedding model.

14. The system of claim 8, wherein a number of the plurality of partitions equals a number of available computing nodes.

15. A computer program product comprising a computer readable storage medium having program instructions embodied therewith, the program instructions executable by one or more processors to cause the one or more processors to perform operations comprising:
receiving a knowledge graph of a data set;
partitioning the knowledge graph into a plurality of partitions;
expanding at least one partition of the plurality of partitions;
launching a training process for each partition of the plurality of partitions, wherein, during a training epoch, a respective training process samples positive and negative samples from a respective partition;
forming, for each training process, an edge mini batch; and
for each edge mini batch, generating a computational graph.

16. The computer program product of claim 15, further comprising determining a gradient according to each respective computational graph.

17. The system of claim 16, further comprising sharing a determined gradient across two or more partitions of the plurality of partitions.

18. The system of claim 17, further comprising determining a updated embedding model according to an average of the gradients.

19. The system of claim 15, wherein partitioning the knowledge graph comprises partitioning the knowledge graph into P disjoint subsets.

20. The system of claim 15, wherein expanding the at least one partition comprises adding n-hops of neighbors of each vertex in the respective partition, where n is equal to a number of graph convolutional layers in an embedding model.
